(19) United States
(12) Patent Application Publication
(10) Pub. No.: US 2008/0186266 A1
(43) Pub. Date: Aug. 7, 2008

(54) DISPLAY DRIVER IC HAVING EMBEDDED MEMORY

(75) Inventor: Hiroyuki TAKAHASHI, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/971,222

(22) Filed: Jan. 9, 2008

(30) Foreign Application Priority Data
Feb. 6, 2007 (JP) 2007-026430

(51) Int. Cl. G09G 3/36

(52) U.S. Cl. 345/87

(57) ABSTRACT

A display driver IC for controlling display of an image on a display panel is provided with a memory and a switch circuit. The memory, in which digital data corresponding to the image is stored, operates with a first voltage. The switch circuit turns ON and OFF supply of the first voltage to the memory. The switch circuit operates with a second voltage that is higher than the first voltage.

### INCORPORATION BY REFERENCE

This application is based upon and claims the benefit of priority from Japanese patent application No. 2007-026430, filed on Feb. 6, 2007, the disclosure of which is incorporated herein in its entirely by reference.

### BACKGROUND OF THE INVENTION

1. Field of the Invention

The present invention relates to a display driver IC (Integrated Circuit) for controlling display of an image on a display panel. In particular, the present invention relates to a display driver IC having an embedded memory.

2. Description of Related Art

A liquid crystal display (LCD) is known as a kind of image display apparatuses. The liquid crystal display is provided with an LCD panel on which an image is displayed and an LCD driver IC that is an IC chip for controlling the image display. The LCD driver IC converts digital data (display data) corresponding to the image into gray-scale voltages, and applies the gray-scale voltages to pixels of the LCD panel. As a result, the image is displayed on the LCD panel.

In general, an SRAM (Static RAM) is used as a memory for storing the display data (refer to Japanese Laid-Open Patent Application JP-P2005-215643, for example). The SRAM may be provided separately from the LCD driver IC or may be provided within the LCD driver IC. In the case where the SRAM is provided within the LCD driver IC, the SRAM is specifically called an “embedded SRAM (eSRAM)”.

In general, when the liquid crystal display enters a standby mode, the SRAM in which the display data is stored enters a standby mode as well. In order to reduce electric power consumption, it is important to suppress a leakage current in the SRAM in the standby mode. For example, a cell-phone described in Japanese Laid-Open Patent Application JP-P2005-215643 is provided with two screens of a main display and a sub-display, and an SRAM is segmented into a memory region for the main display and a memory region for the sub-display. According to such the cell-phone, sometimes the main display is not used and only the sub-display is used. In this case, it is important to suppress the leakage current in the memory region for the main display.

A technique for suppressing a leakage current in an SRAM cell is described in Japanese Laid-Open Patent Application No. JP-P2005-293629. According to the technique, a switch transistor is provided between a power line or a ground line and the SRAM cell and is switched in synchronization with a word line. Specifically, the switch transistor is turned ON when the word line is activated, while turned OFF during a data retention status. In the case of the OFF state, a voltage effectively applied to the SRAM cell becomes decreased and hence the leakage current is reduced due to a DIBL (Drain Induced Barrier Lowering) effect and a substrate bias effect.

The inventor of the present application has recognized the following points. It is conceivable to provide a power-controlling switch transistor between a power supply and an SRAM in order to suppress the leakage current in the SRAM in the standby mode. In the case where the switch transistor is simply provided between the power supply and the SRAM, however, there is a concern that a memory operation becomes unstable during a normal operation mode due to potential drop at the switch transistor. If an area of the switch transistor is expanded for reducing the potential drop as much as possible, an chip area is increased.

### SUMMARY

In one embodiment of the present invention, a display driver IC having an embedded memory is provided. That is to say, the display driver IC according to the one embodiment is provided with a built-in memory in which digital data corresponding to a display image is stored. In order to increase the integration degree, a memory cell of the memory is generally comprised of a low voltage transistor.

The display driver IC according to the one embodiment is further provided with a switch circuit that turns ON and OFF electric power supply to the memory. Therefore, an off-leakage current in the memory in the standby mode is reduced. Moreover, the memory is configured to operate with a first voltage, while the switch circuit is configured to operate with a second voltage that is higher than the first voltage. In other words, a breakdown voltage of a switch transistor used in the switch circuit is higher than a breakdown voltage of a cell transistor used in the memory, and a high voltage transistor is used as the switch transistor. Since driving capability of the switch transistor is high, the above-mentioned problem can be solved. That is to say, it is possible during the normal operation mode to prevent the memory operation from becoming unstable due to potential drop at the switch transistor.

According to the display driver IC of the present invention, the leakage current in the embedded memory in the standby mode can be reduced by the switch circuit. Furthermore, it is possible during the normal operation mode to prevent the memory operation from becoming unstable due to the potential drop at the switch transistor.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a display apparatus provided with a display driver IC according to a first embodiment of the present invention;

FIG. 2 is a graph showing one example of a relationship between gray-scales and gray-scale voltages;

FIG. 3 is a block diagram schematically showing a display driver IC according to a second embodiment of the present invention;

FIG. 4 is a block diagram schematically showing a display driver IC according to a third embodiment of the present invention;

FIG. 5 is a diagram for explaining various power control modes;

FIG. 6 is a block diagram showing a configuration of a display apparatus provided with a display driver IC according to a fourth embodiment of the present invention; and

FIG. 7 is a block diagram schematically showing a display driver IC according to the fourth embodiment.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display apparatus and a display driver IC according to embodiments of the present invention will be described with reference to the accompanying drawings. The display apparatus is exemplified by a liquid crystal display.

### 1. First Embodiment

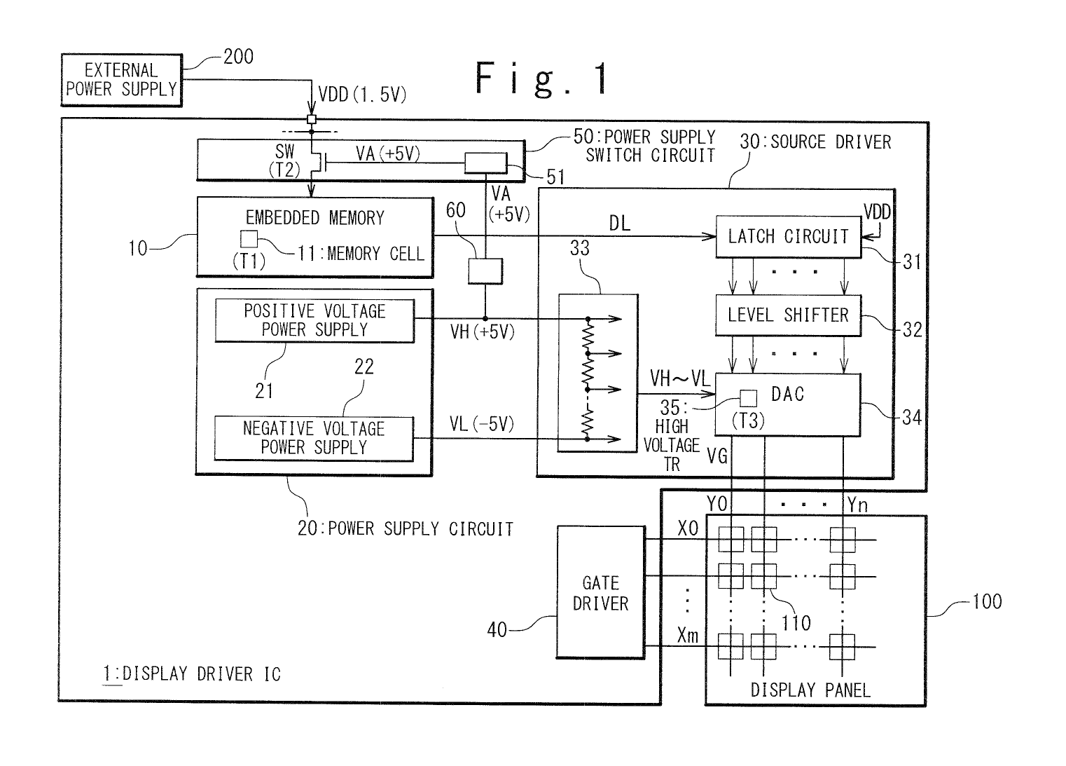

FIG. 1 is a block diagram showing a configuration of a display apparatus according to a first embodiment of the present invention. The display apparatus is provided with a display driver IC 1 and a display panel 100. The display driver IC 1 is an IC for controlling image display on the display panel 100 and is integrated on a single chip. A power supply voltage VDD (e.g. 1.5 V) is supplied to the display driver IC 1 from an external power supply 200.

The display panel 100 is an LCD panel, for example. The display panel 100 has a plurality of pixels 110 that are arranged in a matrix form. Also, a plurality of gate lines X0 to Xm and a plurality of source lines Y0 to Yn are so formed as to intersect with each other, and the pixels 110 are formed at respective intersections. Each of the pixels 110 includes a TFT (Thin Film Transistor), a liquid crystal element, and a common electrode. One end of the liquid crystal element is connected to the TFT, and the other end is connected to the common electrode to which a predetermined common voltage VCOM is applied.

One gate line X is connected to the pixels 110 of one line, and the display driver IC 1 applies gray-scale voltages (pixel voltages) corresponding to gray-scales of a display data simultaneously to the pixels 110 of one line through the source lines Y0 to Yn, respectively. The gate lines X0 to Xm are driven in order and thereby the image is displayed on the display panel 100. Here, a typical liquid crystal display employs an “inversion driving method” such as a frame inversion driving method, a line inversion driving method, or a dot inversion driving method, for the purpose of reducing flicker and suppressing deterioration of the liquid crystal element. According to the inversion driving method, a “polarity” of the pixel voltage applied to the pixel 110 is inverted every predetermined period, or the “polarity” is inverted between adjacent pixels 110. Here, the “polarity” indicates whether the pixel voltage is positive or negative with respect to the common voltage VCOM of the common electrode as a reference. That is, two kinds of gray-scale voltages, i.e. a positive-polarity gray-scale voltage and a negative-polarity gray-scale voltage are used with regard to one gray-scale.

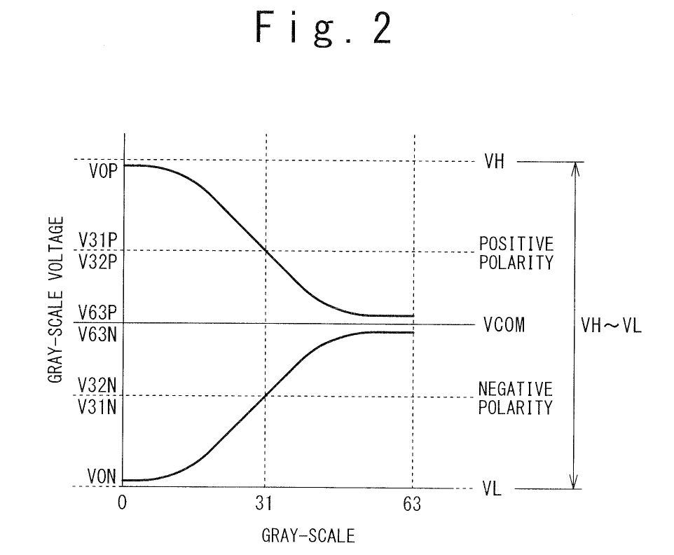

FIG. 2 shows one example of a relationship between gray-scales and gray-scale voltages (pixel voltages) in a case of 64-level gray-scale representation. With regard to the positive-polarity side, positive-polarity gray-scale voltages V0P to V63P are related to the 0th to 63rd gray-scales in this order. With regard to the negative-polarity side, on the other hand, negative-polarity gray-scale voltages V0N to V63N are related to the 0th to 63 rd gray-scales in this order. In a case where the common voltage VCOM is a ground voltage, the positive-polarity gray-scale voltages V0P to V63P are positive voltages and within a positive voltage range VH to VCOM. On the other hand, the negative-polarity gray-scale voltages V0N to V63N are negative voltages and within a negative voltage range VCOM to VL. In the present embodiment, let us consider a case where both the positive voltage range VH to VCOM and the negative voltage range VCOM to VL are used.

Referring back to FIG. 1, the display driver IC 1 according to the present embodiment will be described below in detail.

The display driver IC 1 is provided with a memory 10. The memory 10 is used for storing display data that is digital data corresponding to an image to be displayed on the display panel 100. That is to say, the display driver IC 1 has the embedded memory 10 for use in storing the display data. An embedded SRAM is used as the embedded memory 10, for example. The embedded memory 10 includes a plurality of memory cells 11. In order to increase the integration degree, the memory cell 11 is comprised of a low voltage transistor T1 (hereinafter referred to as a “cell transistor T1”). Also, the power supply voltage VDD (1.5 V) is supplied to the embedded memory 10 from the external power supply 200, and the embedded memory 10 and the cell transistors T1 operate with the power supply voltage VDD.

The display driver IC 1 is further provided with a power supply circuit 20, a source driver 30 (driver circuit) and a gate driver 40 which are for use in display drive control.

The power supply circuit 20 is configured to output internal voltages that are used for generating the gray-scale voltages (pixel voltages) applied to the pixels 110. In the present embodiment, the positive voltage range VH to VCOM and the negative voltage range VCOM to VL as shown in FIG. 2 are used as the gray-scale voltages. For that purpose, the power supply circuit 20 includes a positive voltage power supply 21 that generates the positive voltage VH and a negative voltage power supply 22 that generates the negative voltage VL. An upper limit of the absolute values of the gray-scale voltages is larger than the power supply voltage VDD (1.5 V). For example, the positive voltage VH and the negative voltage VL are +5 V and −5 V, respectively. In this manner, the power supply circuit 20 generates the high voltages VH and VL that are larger than the power supply voltage VDD. Those high voltages VH and VL are supplied to the source driver 30.

The source driver 30 receives a display data DL for one line from the embedded memory 10. Then, the source driver 30 converts the display data DL into the corresponding gray-scale voltages VG, and outputs the gray-scale voltages (pixel voltages) VG to the display panel 100 through the source lines Y0 to Yn. More specifically, the source driver 30 includes a latch circuit 31, a level shifter 32, a gray-scale voltage generation circuit 33 and a DA converter 34.

The latch circuit 31 latches the display data DL for one line. The display data DL is supplied to the DA converter 34 through the level shifter 32. Meanwhile, the gray-scale voltage generation circuit 33 receives the positive voltage VH (+5 V) and the negative voltage VL (−5 V) from the power supply circuit 20. The gray-scale voltage generation circuit 33 has a plurality of voltage divider resistors that are connected in series, and generates a plurality kinds of gray-scale voltages through the voltage division based on reference voltages including the positive voltage VH, the negative voltage VL and the like. The plurality kinds of gray-scale voltages are the positive-polarity gray-scale voltages V0P to V63P and the negative-polarity gray-scale voltages V0N to V63N shown in FIG. 2, which are within a voltage range from VH to VL. The gray-scale voltage generation circuit 33 outputs the plurality kinds of gray-scale voltages to the DA converter 34. Based on the plurality kinds of gray-scale voltages, the DA converter 34 outputs the gray-scale voltages corresponding to the received display data DL. In this manner, the source driver 30 converts the display data DL into the corresponding gray-scale voltages by using the voltage range VH to VL that is defined by the positive voltage VH and the negative voltage VL. The output gray-scale voltages are applied as the pixel voltages VG to the pixels 110 of the display panel 100.

Since the source driver 30 needs to handle the high voltages VH and VL that are larger than the power supply voltage VDD, the source driver 30 has a high voltage element 35. For example, an output stage of the DA converter 34 for outputting the gray-scale voltage VG is comprised of a high voltage transistor T3. A breakdown voltage of the high voltage transistor T3 used in the source driver 30 is larger than a breakdown voltage of the cell transistor T1 used in the embedded memory 10.

The gate driver 40 is connected to the gate lines X0 to Xm and drives the gate lines X0 to Xm in order.

Furthermore, as shown in FIG. 1, the display driver IC 1 is provided with a power supply switch circuit 50. The power supply switch circuit 50 is provided between the external power supply 200 and the embedded memory 10, and is configured to switch the supply of the power supply voltage VDD to the embedded memory 10. At a time of a normal operation mode, the power supply switch circuit 50 turns ON the supply of the power supply voltage VDD to the embedded memory 10. At a time of a standby mode, on the other hand, the power supply switch circuit 50 turns OFF the supply of the power supply voltage VDD to the embedded memory 10. Consequently, an off-leakage current in the embedded memory 10 in the standby mode can be reduced.

More specifically, the power supply switch circuit 50 includes a power control logic circuit 51 and a switch SW. The switch SW is comprised of a switch transistor T2 (MOS transistor), which is provided between the external power supply 200 and the embedded memory 10. A gate terminal of the switch transistor T2 is connected to the power control logic circuit 51. The power control logic circuit 51 turns ON and OFF the switch transistor T2, depending on the operation mode. At a time of the normal operation mode, the power control logic circuit 51 turns ON the switch transistor T2. Accordingly, the switch transistor T2 outputs the power supply voltage VDD to the embedded memory 10. On the other hand, at a time of the standby mode, the power control logic circuit 51 turns OFF the switch transistor T2. As a result, an electrical connection between the external power supply 200 and the embedded memory 10 is cut off.

According to the present embodiment, the embedded memory 10 operates with the power supply voltage VDD (1.5 V), while the power supply switch circuit 50 is configured to operate with a voltage VA that is higher than the power supply voltage VDD. The high voltage VA is +5 V, for example. As shown in FIG. 1, the high voltage VA (+5 V) is applied to the gate terminal of the switch transistor T2, depending on the operation mode. Therefore, a high voltage transistor that is different from the cell transistor T1 in the embedded memory 10 is used as the switch transistor T2 in the power supply switch circuit 50. That is, a breakdown voltage of the switch transistor T2 is higher than the breakdown voltage of the cell transistor T1. Since driving capability of the switch transistor T2 is high, it is possible during the normal operation mode to prevent the memory operation from becoming unstable due to potential drop at the switch transistor T2.

Also, the same one as the high voltage transistor T3 in the source driver 30 can be used as the switch transistor T2 in the power supply switch circuit 50. In other words, it is possible to design the breakdown voltage of the switch transistor T2 to be equal to the breakdown voltage of the high voltage transistor T3. In this case, both of the switch transistor T2 in the power supply switch circuit 50 and the high voltage transistor T3 in the source driver 30 can be fabricated through the same process. As a result, a structure of the switch transistor T2 can be the same as that of the high voltage transistor T3. To conform the structure of the switch transistor T2 to the structure of the high voltage transistor T3 is preferable, because it becomes unnecessary to add a special process for manufacturing the high voltage transistor for use in the power supply switch circuit 50. This can be said to be ingenuity peculiar to the display driver IC 1, since the display driver IC 1 has the high voltage transistor T3 in the source driver 30 for handling the high voltages VH and VL.

Furthermore, the above-mentioned power supply circuit 20 used for the display drive control can be utilized as an operation power supply for the power supply switch circuit 50 which operates with the high voltage VA. In other words, it is possible that the source driver 30 and the power supply switch circuit 50 share the same power supply circuit 20. For example, as shown in FIG. 1, the positive voltage VH (+5 V) output from the positive voltage power supply 21 is also supplied as the high voltage VA (+5 V) to the power supply switch circuit 50. That is to say, electric power is supplied to the power supply switch circuit 50 from the power supply circuit 20 that is originally provided for use in the display drive control. In this case, it is unnecessary to add a special power supply for the power supply switch circuit 50, which is preferable because the chip area can be made small. This can also be said to be ingenuity peculiar to the display driver IC 1, since the display driver IC 1 has the power supply circuit 20 generating the high voltages VH and VL for driving the display panel 100.

It should be noted that, in a case where the power supply circuit 20 is electrically connected with the power supply switch circuit 50, there is a concern for propagation of a switching noise. Therefore, as shown in FIG. 1, a small-scale buffer circuit 60 serving as a filter is provided between the power supply circuit 20 and the power supply switch circuit 50. Also, the high voltage VA is not necessarily equal to the positive voltage VH (+5 V). In a case where the high voltage VA is different from the positive voltage VH, the buffer circuit 60 also serves as a voltage conversion circuit that converts the positive voltage VH into the high voltage VA.

As described above, according to the present embodiment, the off-leakage current in the embedded memory 10 in the standby mode can be reduced by the power supply switch circuit 50. Moreover, it is possible during the normal operation mode to prevent the memory operation from becoming unstable due to the potential drop at the switch transistor T2. Furthermore, it is unnecessary for achieving such the power supply switch circuit 50 to add a special manufacturing process and a special operation power supply.

### 2. Second Embodiment

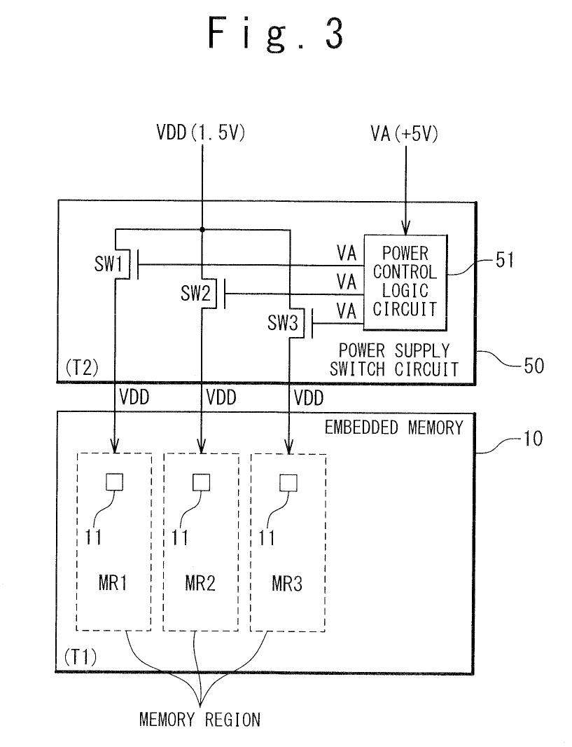

The power supply switch circuit 50 may control the supply of the power supply voltage VDD to the embedded memory 10 separately with respect to each memory region. In FIG. 3, for example, the embedded memory 10 includes memory regions MR1, MR2 and MR3. In order to control the supply of electric power to each of the memory regions MR1, MR2 and MR3, the power supply switch circuit 50 has switches SW1, SW2 and SW3 which are connected to the memory regions MR1, MR2 and MR3, respectively. As in the first embodiment, each of the switches SW1, SW2 and SW3 is comprised of the high voltage transistor T2. The power control logic circuit 51 turns ON and OFF the switches SW1, SW2 and SW3, depending on the operation mode. As a result, the same effects as in the first embodiment can be obtained. In addition, it is possible to perform the power control with respect to each of the memory regions.

For example, the display driver IC 1 according to the present embodiment is used in a cell-phone that has two screens of a main display and a sub-display. In this case, the embedded memory 10 is segmented into a memory region for the main display and a memory region for the sub-display. According to such the cell-phone, sometimes the main display is not used and only the sub-display is used. Therefore, it is important to suppress the leakage current in the memory region for the main display. Also, in a case where a control that reduces color depth is performed, not all the memory regions in the embedded memory 10 need to be used. The present embodiment is particularly effective in such cases.

### 3. Third Embodiment

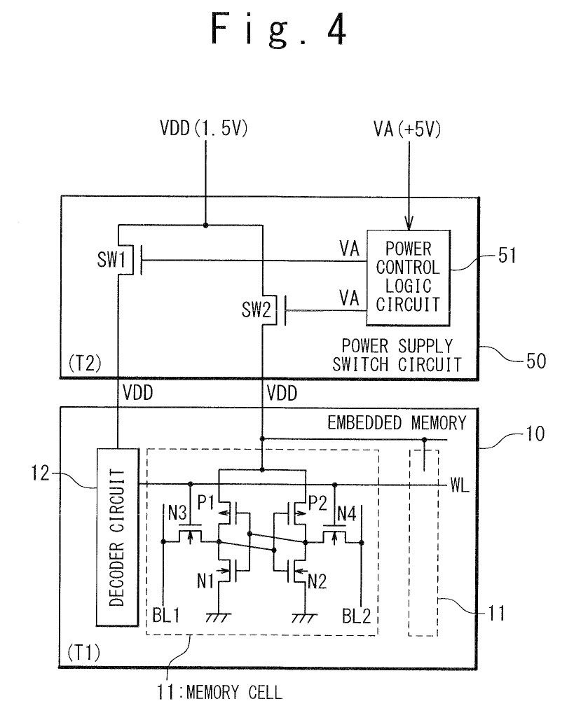

The power supply switch circuit 50 may control the supply of the power supply voltage VDD to the embedded memory 10 separately with respect to the memory cell 11 and a peripheral circuit. For example, as shown in FIG. 4, the embedded memory 10 includes a decoder circuit 12 as the peripheral circuit in addition to the memory cells 11.

The memory cell 11 is an SRAM cell, for example. As shown in FIG. 4, the memory cell 11 is comprised of PMOS transistors P1, P2, NMOS transistors N1, N2, N3 and N4. The PMOS transistor P1 and the NMOS transistor N1 constitute one inverter, and the PMOS transistor P2 and the NMOS transistor N2 constitute the other inverter. Data is retained by these two inverters. The NMOS transistors N3 and N4 are select transistors and connected to bit lines BL1 and BL2, respectively. Gate terminals of the NMOS transistors N3 and N4 are connected to a word line WL. Each of the MOS transistors is the low voltage transistor (cell transistor) T1. The power supply voltage VDD is applied to source terminals of the PMOS transistors P1 and P2. Further, the decoder circuit 12 applies the power supply voltage VDD to a selected word line WL.

In this manner, the memory cells 11 (memory cell array) and the decoder circuit 12 respectively require the power supply voltage VDD. In order to control the supply of the power supply voltage VDD to the memory cell 11 and the decoder circuit 12 separately from each other, the power supply switch circuit 50 includes switches SW1 and SW2. The switches SW1 and SW2 are connected to the decoder circuit 12 and the memory cells 11, respectively. As in the first embodiment, each of the switches SW1 and SW2 is comprised of the high voltage transistor T2. The power control logic circuit 51 turns ON and OFF the switches SW1 and SW2, depending on the operation mode. As a result, the same effects as in the first embodiment can be obtained. In addition, it is possible to perform a precise power control in accordance with the purpose.

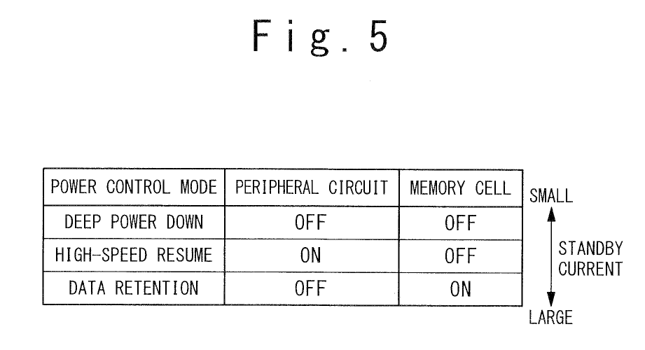

FIG. 5 shows some examples of the power control performed in accordance with the purpose in the present embodiment. In a “data retention mode”, the electric power supply to the peripheral circuit is turned OFF, while the electric power supply to the memory cell is maintained ON. In this case, the data of the memory cell remains retained. In a “high-speed resume mode”, the electric power supply to the memory cell is turned OFF, while the electric power supply to the peripheral circuit is maintained ON. In this case, high-speed resumption of the memory operation is possible. Furthermore, the reduction effect of the standby electric power consumption can be obtained considerably, because most of the off-leakage current is generated in the memory cells. In a “Deep power down mode”, the electric power supply to both the peripheral circuit and the memory cell is turned OFF. In this case, the best reduction effect of the standby electric power consumption can be obtained.

It is also possible to combine the second embodiment and the third embodiment. In that case, a more precise power control becomes possible.

### 4. Fourth Embodiment

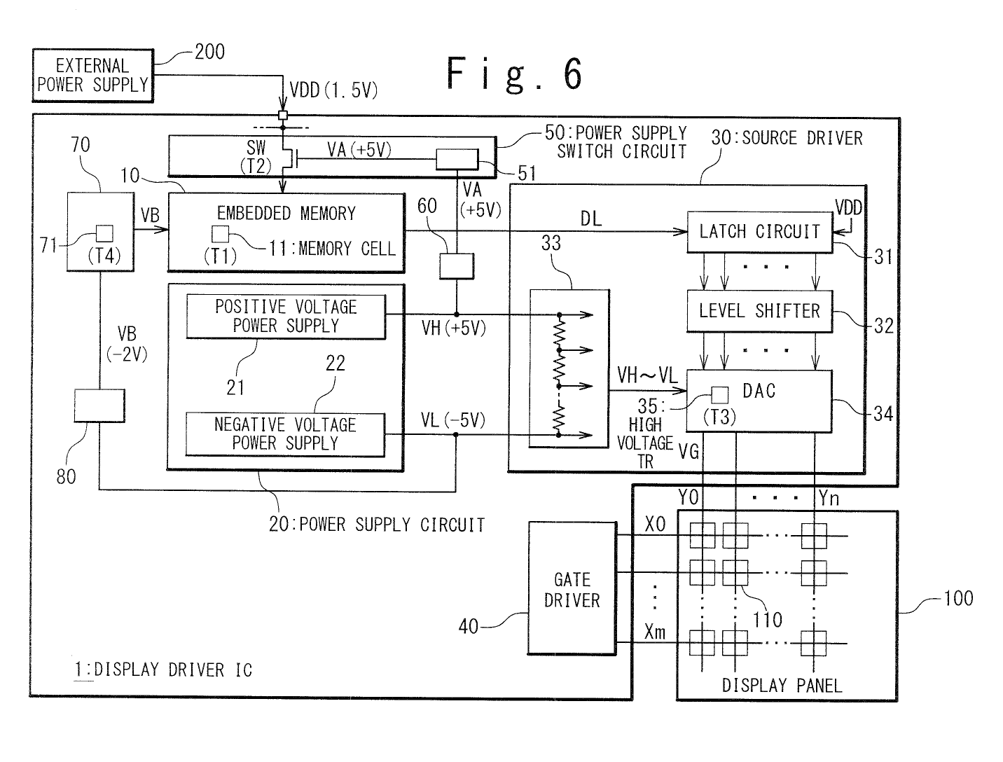

FIG. 6 is a block diagram showing a configuration of a display apparatus according to a fourth embodiment of the present invention. In FIG. 6, the same reference numerals are given to the same components as those described in the first embodiment, and an overlapping description will be omitted as appropriate. As shown in FIG. 6, the display driver IC 1 according to the present embodiment further has a well voltage control circuit 70 and a buffer circuit 80. The buffer circuit 80 is provided between the power supply circuit 20 and the well voltage control circuit 70.

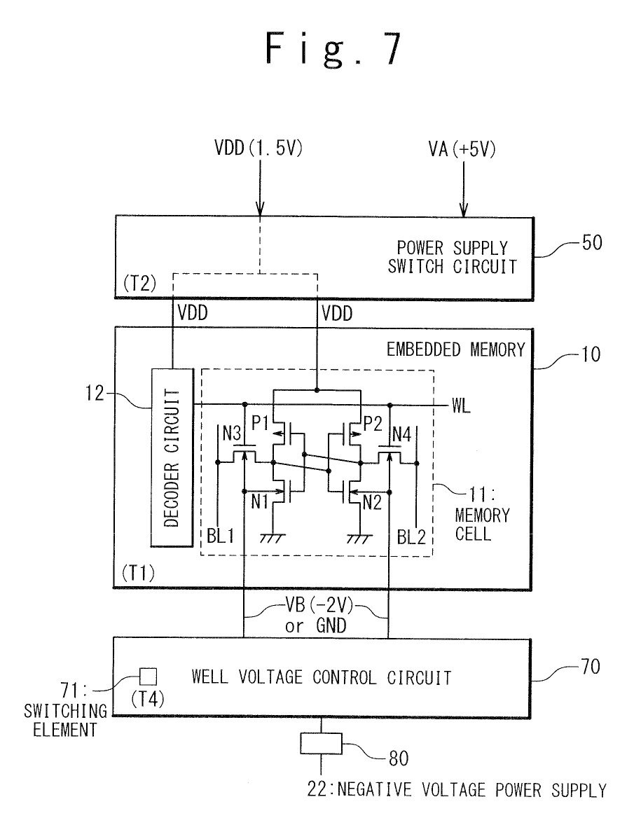

FIG. 7 schematically shows a part of the display driver IC 1 according to the present embodiment. The embedded memory 10 includes the memory cell 11 and the decoder circuit 12. The same SRAM cell as in FIG. 4 described above is shown as the memory cell 11.

The well voltage control circuit 70 is a circuit for switching a voltage of a well on which the cell transistor T1 of the embedded memory 10 is formed. As shown in FIG. 7, the well voltage control circuit 70 applies a negative voltage VB or the ground voltage GND to back gates of the NMOS transistors N1 to N4. More specifically, the well voltage control circuit 70 applies the negative voltage VB (e.g. −2 V) to those back gates at the time of the standby mode. As a result, threshold voltages of the NMOS transistors N1 to N4 are increased, and thus the off-leakage current in the embedded memory 10 is further reduced at the time of the standby mode. At the time of the normal operation mode, on the other hand, the well voltage control circuit 70 applies the ground voltage GND to the back gates. As a result, a high-speed operation can be achieved at the time of the normal operation mode.

As described above, the well voltage control circuit 70 switches and outputs the negative voltage VB and the ground voltage GND. Therefore, the well voltage control circuit 70 has a switching element 71 for switching and outputting the voltages. Since the negative voltage VB of about −2 V needs to be output, the switching element 71 is comprised of a high voltage transistor T4. That is to say, the high voltage transistor T4 which is different from the cell transistor T1 in the embedded memory 10 is used as the switching element 71.

As in the case of the switch transistor T2 mentioned above, the same one as the high voltage transistor T3 in the source driver 30 can be used as the high voltage transistor T4 in the well voltage control circuit 70. In other words, it is possible to design the breakdown voltage of the high voltage transistor T4 to be equal to the breakdown voltage of the high voltage transistor T3. In this case, both of the high voltage transistor T4 in the well voltage control circuit 70 and the high voltage transistor T3 in the source driver 30 can be fabricated through the same process. As a result, a structure of the high voltage transistor T4 can be the same as that of the high voltage transistor T3. It is unnecessary to add a special process for manufacturing the high voltage transistor T4 for use in the well voltage control circuit 70. This can be said to be ingenuity peculiar to the display driver IC 1.

Furthermore, according to the present embodiment, it is possible to utilize the negative voltage VL (−5 V) generated by the above-described negative voltage power supply 22 for generating the negative voltage VB (−2 V). In other words, it is possible that the source driver 30 and the well voltage control circuit 70 share the negative voltage power supply 22. A small-scale buffer circuit 80 is provided between the negative voltage power supply 22 and the well voltage control circuit 70. The buffer circuit 80 serves as not only a filter for preventing the propagation of a switching noise but also a voltage conversion circuit that converts the negative voltage VL (−5 V) into the negative voltage VB (−2 V) In this manner, electric power is supplied to the well voltage control circuit 70 from the negative voltage power supply 22 that is originally provided for use in the display drive control. Since it is unnecessary to add a special power supply for the well voltage control circuit 70, increase in the chip area can be suppressed. This can also be said to be ingenuity peculiar to the display driver IC 1.

According the fourth embodiment, the same effects as in the first embodiment can be obtained. In addition, since the negative voltage VB is applied to the well at the time of the standby mode, the off-leakage current in the embedded memory 10 can be further reduced. Moreover, it is unnecessary to add a special manufacturing process and a special operation power supply for achieving the well voltage control circuit 70. It is also possible to combine the fourth embodiment with the foregoing second embodiment or the third embodiment. In that case, a precise power control can be achieved.

It is apparent that the present invention is not limited to the above embodiments and may be modified and changed without departing from the scope and spirit of the invention.

What is claimed is:

1. A display driver IC for controlling display of an image on a display panel, comprising:
a memory configured to operate with a first voltage, in which digital data corresponding to said image is stored; and
a switch circuit configured to operate with a second voltage that is higher than said first voltage and to turn ON and OFF supply of said first voltage to said memory.

2. The display driver IC according to claim 1, further comprising:
a power supply circuit configured to generate a third voltage that is higher than said first voltage; and
a driver circuit configured to convert said digital data into a gray-scale voltage by using said third voltage and to output said gray-scale voltage to said display panel,
wherein electric power is supplied to said switch circuit from said power supply circuit.

3. The display driver IC according to claim 2, further comprising a buffer circuit provided between said power supply circuit and said switch circuit and configured to convert said third voltage into said second voltage.

4. The display driver IC according to claim 2,
wherein a memory cell in said memory has a first transistor configured to operate with said first voltage,
said switch circuit has a second transistor having a gate to which said second voltage is applied and configured to output said first voltage to said memory, and
said driver circuit has a third transistor configured to output said gray-scale voltage,
wherein a breakdown voltage of said second transistor is equal to a breakdown voltage of said third transistor.

5. The display driver IC according to claim 4,
wherein said second transistor has a same structure as said third transistor.

6. The display driver IC according to claim 4, further comprising a well voltage control circuit,
wherein at a time of a standby mode, said well voltage control circuit applies a fourth voltage that is a negative voltage to a well on which said first transistor is formed,
wherein said power supply circuit includes:
a positive voltage power supply configured to generate said third voltage that is a positive voltage; and
a negative voltage power supply configured to generate a fifth voltage that is a negative voltage,
wherein said driver circuit converts said digital data into said gray-scale voltage by using a voltage range defined by said third voltage and said fifth voltage,
wherein said fourth voltage is generated from said fifth voltage generated by said negative voltage power supply.

7. The display driver IC according to claim 6,
wherein said well voltage control circuit has a fourth transistor configured to output said fourth voltage, and a breakdown voltage of said fourth transistor is equal to a breakdown voltage of said third transistor.

8. The display driver IC according to claim 7,
wherein said fourth transistor has a same structure as said third transistor.

9. The display driver IC according to claim 1,
wherein said switch circuit controls supply of said first voltage to said memory separately with respect to each of regions in said memory.

10. The display driver IC according to claim 1,
wherein said memory includes a memory cell and a peripheral circuit,
wherein said switch circuit controls supply of said first voltage to said memory cell and supply of said first voltage to said peripheral circuit separately from each other.
